(19) United States
(12) Patent Application Publication
(10) Pub. No.: US 2005/0286702 A1
(43) Pub. Date: Dec. 29, 2005

(54) System and method for providing called terminal time in a telecommunications network

(75) Inventors: Yu Yin, Aurora, IL (US); Peggy Hasan, Aurora, IL (US); Frances Mu-Fen Chin, Naperville, IL (US); Sandra Lynn True, St. Charles, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/875,873

(22) Filed: Jun. 24, 2004

(51) Int. Cl. H04M 3/42

(52) U.S. Cl. 379/207.12; 379/211.02

(57) ABSTRACT

A system and method of routing calls in a telecommunications network is provided. The method includes receiving an incoming call for the called party, determining the called terminal location, selecting a long distance carrier preferred by the called party for incoming calls made to the called terminal location, and routing the call to the called party using the selected long distance carrier. The system includes means for receiving an incoming call for the called party, means for determining the called terminal location, means for selecting a long distance carrier preferred by the called party for incoming calls made to the called terminal location, and means for routing the call to the called party using the selected long distance carrier.

### BACKGROUND OF THE INVENTION

This invention relates to the art of telecommunications and more particularly to a system and method for routing a call in a telecommunications network by providing the current time at the called terminal location.

Telecommunications systems enable a calling party to communicate with a called party by providing either circuit switched or packet-based connection between a calling terminal and a wireless called terminal. Wireless terminals enable a called party to roam, that is travel outside of their home wireless network, and still use the wireless terminals for making and receiving calls.

However, when calling, the calling party may not be aware that the called party is roaming. This can lead to the calling party calling the called party at a time which is inconvenient for the called party, such as for example late at night. It is desirable to make the calling party aware of the time at the called party's location.

### SUMMARY OF THE INVENTION

According to the present invention, a method of routing a call to a wireless called party terminal in a telecommunications network is provided.

In accordance with a first aspect of the invention, the method includes determining the current time at the called terminal location, and providing the current time at the called terminal location to the calling terminal prior to completing call setup.

In accordance with a second aspect of the invention, the method also includes querying a Termination Switch for the current time at the called terminal location.

A system for routing a call to a wireless called party terminal in a telecommunications network is also provided.

In accordance with another aspect of the invention, the system includes means for determining the current time at the called terminal location, and means for providing the current time at the called terminal location to the calling terminal prior to completing call setup.

In accordance with yet another aspect of the invention, the means for determining the current time at the called terminal location is a Termination Switch.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The invention may take form in various components and arrangements of components, and in various steps and arrangements of steps. The drawings are only for purposes of illustrating preferred embodiments and are not to be construed as limiting the invention. Further, it is to be appreciated that the drawings are not to scale.

FIG. 1 is a block diagram illustrating a system for routing a call from a calling terminal to a wireless called terminal in a telecommunications network in accordance with the present invention;

FIG. 2 is a flow chart illustrating a method of routing a call in accordance with the invention; and

FIG. 3 is a flow chart illustrating a method of routing a call in accordance with the invention.

### DETAILED DESCRIPTION OF THE INVENTION

Referring to FIG. 1, a portion of a telecommunications network is shown generally at 10. The telecommunications network 10 provides communication between a calling terminal 12 and a called terminal 14. A calling party uses the calling terminal 12 to call the called party who receives the call on the called terminal 14. The invention can be made available on a subscription basis to subscribers and the calling party can also be referred to as a subscriber. The calling terminal 12 can be a PSTN wireline terminal or a wireless terminal, also known as a cellular phone. The called terminal 14 can be any suitable known wireless terminal.

The telecommunications network 10 includes an Origination Switch 16 for connecting the calling terminal 12 to the telecommunications network 10. The Origination Switch 16 can be used for setting up calls made by the calling terminal 12 and for routing calls from the calling terminal 12 to the called terminal 14 via the Public Switched Telephone Network (PSTN) 18.

The telecommunications network 10 also includes a Termination Switch 20 for connecting the wireless called terminal 14 to the telecommunications network 10 via a base station (not shown). The Termination Switch 20 can be used for setting up calls made to the called terminal 14, for routing calls from the calling terminal 12 to the called terminal 14 via the PSTN 18, and for routing calls from the called terminal 14 to other terminals including the calling terminal 12.

The Termination Switch 20 can determine the current time at the called terminal location, also referred to as the called terminal time. The called terminal time is typically the current time at the Termination Switch 20 though it may be different. The Termination Switch 20 can determine the current time using a processor clock or in any other suitable manner. As used herein, the current time at the called terminal location can also include the day and/or the date.

The Termination Switch 20 can be a Mobile Switching Center (MSC) suitable for connecting wireless terminals to the telecommunications network 10. The MSC can be a home MSC located in the home wireless communications network (not shown) of the called terminal 14 or it can be a visiting MSC responsible for connecting the called terminal 14 to the telecommunications network 10 when the called party is roaming.

The telecommunications network 10 also includes a Service Control Point (SCP) 22. The SCP 22 is a well known node in the telecommunications network 10 which typically performs call setup procedures and call routing. The SCP 22 is typically queried during call setup for determining how to route the call to the Termination Switch 20 and to the called terminal 14.

The operation of the invention shall be described using an example, which should not be considered limiting, and a series of method steps. For the example provided herein, the called party is visiting Tokyo Japan, roaming outside of their home wireless network located in Chicago, Ill. Thus, the called terminal 14 is at the called terminal location of Tokyo, Japan when the call is made. The calling party, for the purposes of this example, is located in New York, N.Y. At 9:30 am Monday morning in New York the calling party calls the called party by calling the called terminal 14. The calling party knows that the called party is typically in Chicago and is unaware that the called party is roaming in Tokyo. The calling party expects that the current time at the called terminal location is 8:30 am Monday morning. However, since the called party and called terminal 14 are in Tokyo the current time at the called terminal location is actually 12:30 am Tuesday morning.

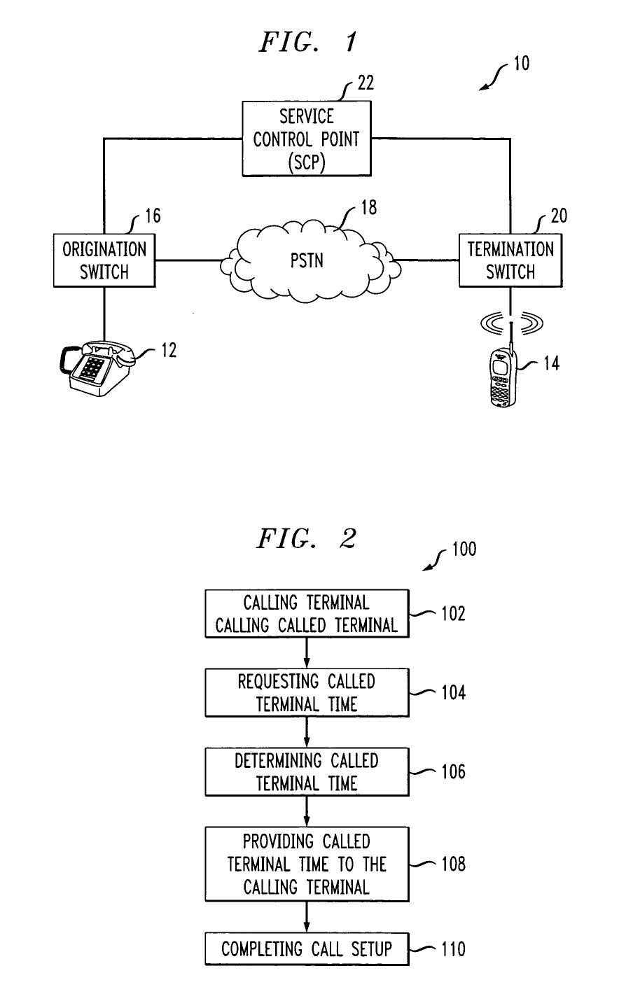

Referring now to FIG. 2, a method of routing a call from a calling terminal to a wireless called terminal in a telecommunications network is shown generally at 100. The method 100 includes the calling terminal 12 calling the called terminal 14 at 102. The calling party calls the called party initiating an incoming call from the calling terminal 12 to the called terminal 14 over the telecommunications network 10.

The method 100 also includes requesting the called terminal time at 104. The requesting step can include the Origination Switch 16 requesting called terminal time using one or more call control messages, such as ANSI 41 SS7 type query messages or using any other suitable protocols. Any suitable information identifying the calling terminal 12, called terminal 14, Origination Switch 16, and/or the Termination Switch 20 for routing the request to the SCP 22 and/or the Termination Switch 20 can be included in the requesting step 104. The requesting step 104 can be performed during call setup.

The method 100 also includes determining the current time at the called terminal location (12:30 am Tuesday) at 106 in any suitable known manner. For example, the Termination Switch 20 located at/near the called terminal 14 can provide the local time and date information. The method 100 also includes providing the called terminal time to the calling terminal prior to completing call setup at 108 and completing call setup between the calling terminal 12 and the called terminal 14 at 110.

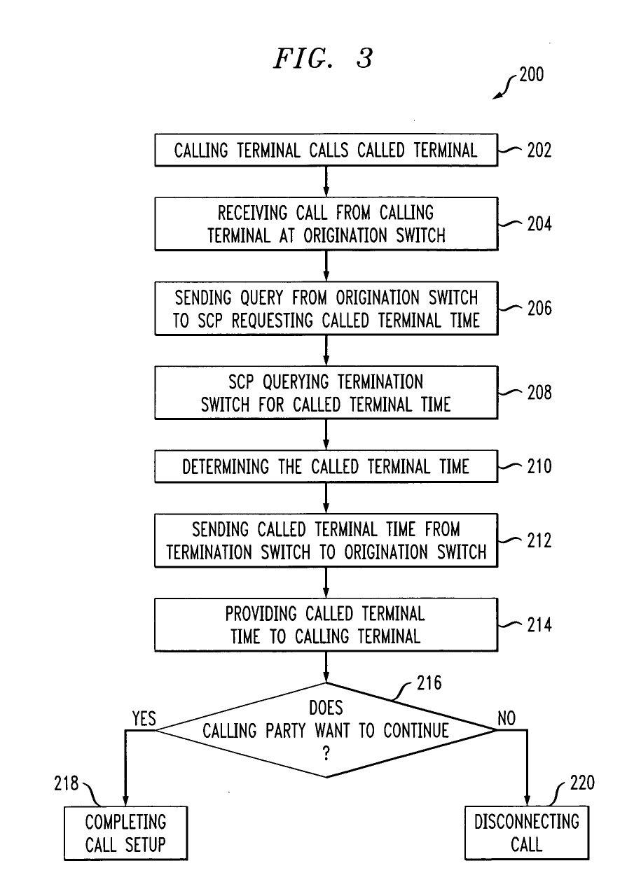

Referring now to FIG. 3, the invention can include the method of routing a call from a calling terminal to a wireless called terminal in a telecommunications network shown generally at 200. The same example of the called party roaming in Tokyo Japan shall be used. The method 200 includes the calling terminal 12 calling the called terminal 14 at 202.

The method 200 also includes receiving the incoming call made to the called terminal 14 at the Origination Switch 16 at 204. The Origination Switch 16 can receive the call in the form of call control messaging, such as an ANSI 41 SS7 INVITE message during call setup, or in any other suitable known manner, prior to the completion of call setup.

For the step of requesting the called terminal time shown in 104 of FIG. 1, the method 200 can include sending a query at 206 from the Origination Switch 16 to the SCP 20 requesting the called terminal time. The query can include one or more call control messages, such as ANSI 41 SS7 type messages or using any other suitable protocols. Any suitable information identifying the calling terminal 12, called terminal 14, Origination Switch 16, and/or the Termination Switch 20 suitable for routing the query between the Origination Switch 16 and the SCP 22 can be included in the query.

For the step of requesting the called terminal time shown in 104 of FIG. 1, the method 200 can also include sending a query at 208 from the SCP 22 to the Termination Switch 20 requesting the called terminal time. The query at 208 can include one or more call control messages using a similar protocol as the query in 206. Any suitable information identifying the calling terminal 12, called terminal 14, Origination Switch 16, Termination Switch 20 suitable for routing the query between the SCP 22 and the Termination Switch 20 can be included in the query.

The method 200 also includes determining the called terminal time (12:30 am Tuesday) at 210. The called terminal time can be determined by the Termination Switch 20 as described above, or in any other suitable manner.

For the step of providing the called terminal time shown in 108 of FIG. 1, the method 200 can include sending the called terminal time from the Termination Switch 20 to the Origination Switch 16 at 212. The called terminal time can be sent using one or more call control messages, such as ANSI 41 SS7 type messages or using any other suitable protocols. Any suitable information identifying the calling terminal 12, called terminal 14, Origination Switch 16, and/or the Termination Switch 20 for routing the called terminal time from the Termination Switch 20 to the Origination Switch 16 can be included. The called terminal time can be routed to the SCP 22 and passed to the Origination Switch 16 or it can be routed more directly from the to Termination Switch 20 to the Origination Switch 16.

For the step of providing the called terminal time shown in 108 of FIG. 1, the method 200 can also include providing the called terminal time to the calling terminal 12 and thus the calling party at 214. The called terminal time can be provided using a voice message, such as an announcement saying that it is 12:30 am Tuesday at the called terminal location, or a text message, or in any other suitable manner. The Origination Switch 16, or any other suitable node in the network 10, can provide this message to the calling terminal 12.

The method 200 also includes providing a message to the calling terminal after the calling party has been provided with the called terminal time asking the calling party whether or not they want to continue with the call at 216. This message can be a voice message, a text message, or any other suitable message and can be provided by the Origination Switch 16 or by any other suitable node in the network 10. If the calling party does not want to continue with the call, for example realizing that the called party is not in Chicago but rather is roaming, the calling party communicates this to the node, such as the Origination Switch 16, and the call is disconnected at 218. If the calling party does want to continue with the call, the calling party communicates this to the node, such as the Origination Switch 16, or does nothing, and call setup is completed at 220 and the calling terminal 12 is connected to the called terminal 14.

As stated, if the calling party is not aware that the called party is roaming, the calling party may not know the current time at the called party's location (i.e., the called terminal time) when calling the called party. As a result, the calling party may call the called party at an inappropriate time, such as for example late at night. The invention enables a calling party to be provided with the called terminal time prior to the completion of call setup. Provided with the called terminal time, the calling party can then decide whether to continue with the call or not. Thus, the invention can prevent the calling party from disturbing the called party with a call at an inappropriate time. Further, the calling party can be provided with the called terminal time prior to call setup which can reduce and/or eliminate the cost of the call to the calling party if the calling party decides not to continue with the call.

It is to be appreciated that particular elements or components described herein may have their functionality suitably implemented via hardware, software, firmware or a combination thereof. Additionally, it is to be appreciated that certain elements described herein as incorporated together may under suitable circumstances be stand alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method of routing a call from a calling terminal to a wireless called terminal in a telecommunications network comprising:
determining the current time at the called terminal location; and
providing the current time at the called terminal location to the calling terminal prior to completing call setup.

2. The method defined in claim 1 further comprising:
requesting the current time at the called terminal location.

3. The method defined in claim 2 wherein the requesting step comprises querying a Service Control Point (SCP) for the current time at the called terminal location.

4. The method defined in claim 2 wherein the requesting step comprises querying a Termination Switch for the current time at the called terminal location.

5. The method defined in claim 1 wherein the providing step comprises sending the current time at the called terminal location to the Origination Switch.

6. The method defined in claim 5 wherein the providing step comprises:
the Termination Switch sending the current time at the called terminal location to the SCP; and
the SCP sending the current time at the called terminal location to the Origination Switch.

7. The method defined in claim 1 wherein the providing step includes an Origination Switch sending the current time at the called terminal location to the calling terminal.

8. The method defined in claim 1 further comprising providing the calling party operating the calling terminal with the option of discontinuing the call prior to completing call setup.

9. The method defined in claim 8 further comprising disconnecting the call.

10. The method defined in claim 1 further comprising providing the calling party operating the calling terminal with the option of continuing the call prior to completing call setup.

11. The method defined in claim 1 further comprising completing call setup.

12. A system for routing a call from a calling terminal to a wireless called terminal in a telecommunications network comprising:
means for determining the current time at the called terminal location; and
means for providing the current time at the called terminal location to the calling terminal prior to the completion of call setup.

13. The system defined in claim 12 wherein the means for determining comprises a Termination Switch.

14. The system defined in claim 12 wherein the means for providing comprises an Origination Switch sending the current time at the called terminal location to the calling terminal.

15. The system defined in claim 14 wherein the means for providing comprises means for sending the current time at the called terminal location to the Origination Switch.

16. The system defined in claim 12 wherein the means for providing comprises a Service Control Point (SCP).

17. The system defined in claim 12 further comprising means for providing the calling party operating the calling terminal with the option of discontinuing the call prior to completing call setup.

18. The method defined in claim 12 further comprising means for requesting the current time at the called terminal location.

19. The method defined in claim 18 wherein the means for requesting comprises a Service Control Point (SCP) querying a Termination Switch for the current time at the called terminal location.

20. The method defined in claim 12 further comprising means for completing call setup.
